(19) United States
(12) Patent Application Publication
(10) Pub. No.: US 2004/0268168 A1
(43) Pub. Date: Dec. 30, 2004

(54) Method and apparatus to reduce power consumption by a display controller

(76) Inventors: Randy P. Stanley, Aptos, CA (US); Aaron M. Tsirkel, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/611,288

(22) Filed: Jun. 30, 2003

(51) Int. Cl. G06F 1/32

(52) U.S. Cl. 713/320

(57) ABSTRACT

A method and apparatus to identify an occurrence of a predetermined event, and reduce power consumption of a display controller in response to the predetermined event. Identifying the occurrence of the event includes identifying a display is in a reduced power mode.

### TECHNICAL FIELD

Embodiments described herein relate to a method and apparatus to reduce power consumption by a display controller.

### BACKGROUND

Power efficiency for computer systems is becoming increasingly important as people are becoming more attuned to energy conservation and power efficiency issues. Specific considerations include the reduction of thermal effects and operating costs. Reducing power consumption in a computer system may result in real energy savings, particularly when multiplied by the large number of installed Personal Computers (PCs) in the world. Also, apart from energy conservation, power efficiency is a concern for battery-operated computer systems, where it is desirable to prolong battery life and minimize battery size in order to enable small and lightweight equipment.

For the standpoint of device design in a computer system, a number of techniques have been used to reduce power usage. These techniques can be grouped as two basic strategies. First, the computer system can be designed in a manner that permits power usage in the device to be managed. Second, the device circuitry can be designed to use less power. In the past, device power management has been primarily at the system level. Various “power down” modes have been implemented, which permit parts of the system, such as a disk drive, display, or the processor itself to be intermittently powered down.

Prior art attempts at conserving power have employed screen blanking which reduces the power to the display screen when the screen has not been used for some period of time. Typically, a timeout circuit senses changes in screen information and, if no change has occurred for a predetermined timeout period, the backlight to the screen is turned off for power reduction. While screen blanking is effective in reducing power for the display screen, no reduction results in power to the driver circuitry for the display, to the graphics controller, or to other parts of the computer.

### BRIEF DESCRIPTION OF DRAWINGS

FIG. 1 is a flow diagram describing the method of reducing power consumption of a display controller according to one embodiment.

FIG. 2 is a flow diagram describing the method of reducing power consumption of a display controller in greater detail according to one embodiment.

FIG. 3 illustrates a system to implement the method according to one embodiment.

### DETAILED DESCRIPTION

A method and apparatus for reducing power consumption by a display controller is described. In one embodiment, an occurrence of a predetermined event is identified. In response to the predetermined event, power consumption of the display controller is reduced. In one embodiment, power consumption of the display controller is reduced in response to a power consumption reduction in a display.

In the following description, numerous specific details are set forth. However, it is understood that embodiments may be practiced without these specific details. In other instances, well-known circuits, structures and techniques have not been shown in detail in order not to obscure the understanding of this description.

Reference throughout this specification to “one embodiment” or “an embodiment” indicate that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

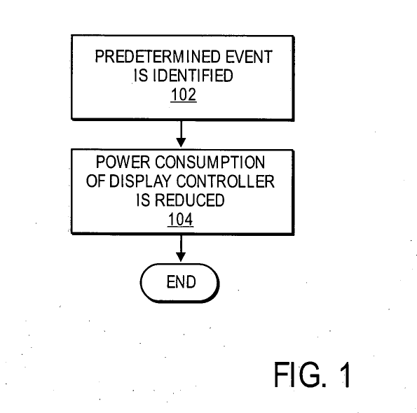

The flow diagram of FIG. 1 describes the process of reducing power consumption in a display controller in accordance with one embodiment. In process 102, occurrence of a predetermined event is identified. In one embodiment, the predetermined event includes power reduction in a display. For example, the display of the computer system powering down in response to the absence of user input for a predetermined period of time, absence of a user being detected by a display user detection device, or alternatively a user may select deactivation of the display by choice. (As described herein “power reduction” and “a reduced power mode” are used interchangeably).

In alternative embodiments, the predetermined event may comprise an alternative event such as the user selecting to place the display controller in reduced power mode, or the computer system in which the display controller resides, being placed in a reduced power mode (e.g. the “Always On” mode, which is described in more detail below). Furthermore, the display, as described herein, may alternatively comprise a monitor, a flat panel, cathode ray tube (CRT) or other types of apparatuses to display data, images, or video.

In process 104, the display controller is placed in a reduced power mode in response to the occurrence of the predetermined event. The power reduction of the display controller may vary from a partial reduction to a complete reduction in power.

As described herein, the display controller converts characters or graphic patterns within a computer's memory into signals used to refresh the display. The display controller generates the content of what is to be displayed by the display. Display controllers may contain their own memory (e.g. frame buffer), which is used to build the images before they are displayed. The display controller may provide dual analog and digital outputs. In one embodiment, the display controller may be built into the motherboard.

Furthermore, as described herein, the display controller as described herein may otherwise be referred to or include a graphics adapter, graphics board, graphics card, graphics controller, a graphics processor, video display controller, video display board, video display card, video display controller, video adapter, video board, video card, video controller, display board, display card, display controller, and other processors, adapters boards, and cards.

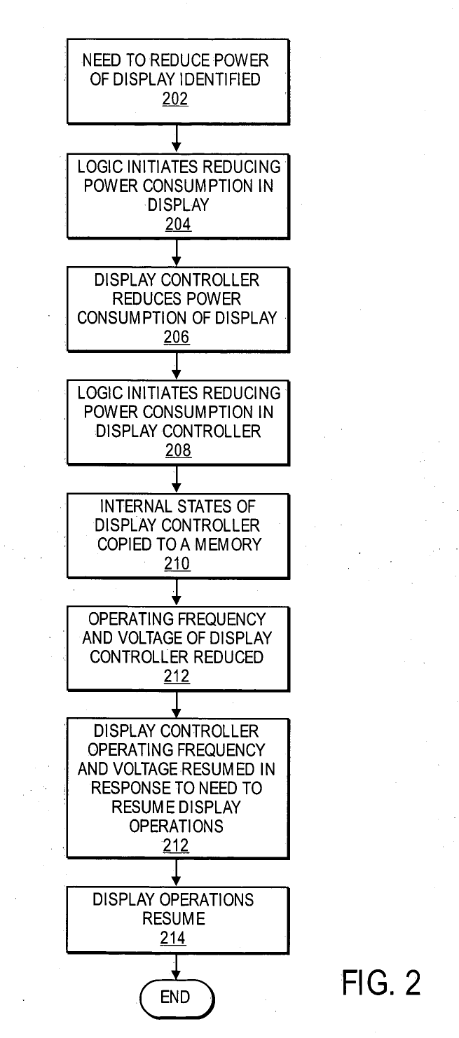

The flow diagram of FIG. 2 describes in greater detail the process of reducing power consumption of a display controller, according to one embodiment. In process 202, a need to reduce power consumption of the display, or some other component, is identified. In one embodiment, the need to reduce the power of the display may be detected by a form of logic, such as the Basic Input Output System (BIOS), the operating system (OS), or alternatively some other application or driver within the system. As stated above, the need to reduce power of the display may, by way of example, occur as a result of the absence of user input for a predetermined period of time or the detecting the absence of a user/computer operator in front of the display via a form of user preferences detection mechanism.

In response to detecting the need to reduce power consumption of the display, in process 204 the logic may cause the display controller to reduce the power consumption of the display. The logic may have a signal or interrupt transmitted to the display controller via a central processing unit (CPU), or have some alternative component transmit a signal or interrupt to the display controller to have the power consumption of the display reduced.

In response to the signal or interrupt to reduce power of the display, in process 206 the display controller reduces the power consumption of the display. In one embodiment, the display controller reduces or terminates the horizontal scan frequency and/or the vertical scan frequency signals to the display. Furthermore, the display controller may also signal a voltage regulator to reduce voltage provided to the display. In alternative embodiments, alternative techniques may be used by the display controller or other components to reduce the power consumption of the display. Furthermore, the amount of reducing the power consumption may vary from partial reduction to complete reduction.

After reducing the power consumption of the display, in process 208 the logic used to initiate the power reduction in the display, as discussed above, initiates reducing power consumption by the display controller. Alternatively, in one embodiment, the display controller may include a built-in power management functions, which responds to the power reduction of the display by reducing its own power consumption.

In process 210, internal states of the display controller, along with data stored in registers of the display controller, are copied in to an area of memory, to be retrieved when power consumption of the display controller is increased.

In one embodiment, in process 212, the operating clock of the display controller reduces the operating frequency of the display, and a voltage regulator of the display controller reduces voltage provided to the display controller. In the case of the logic initiating the reduction in power consumption by the adapter, a signal or interrupt is transmitted to the display controller via a central processing unit (CPU), or some alternative component transmits a signal or interrupt to the display controller to have the power consumption of the display controller reduced. Furthermore, the amount of reducing the power consumption may vary from partial reduction to complete reduction.

In one embodiment, wherein the display controller is integrated on a chipset, a separate power plane is provided to the display controller. For example, the display controller may have a separate clocking and voltage input, both of which could be reduced without affecting the performance of the remainder of the functional units of the chipset. In the case of reducing the power consumption of the display controller which is integrated on a chipset, power would continue to be provided to the remainder of the chipset.

In addition, in alternative embodiments selected features of the display controller may continue to operate. For example, the rasterizer or its equivalent may be placed in a reduced power mode while the display controller and frame buffer continue to operate upon detecting user input activity despite the absence of detecting a computer user present in front of the display. Alternatively, the frame buffer and/or the rasterizer of the display controller may continue to operate when the display controller is placed in a reduced power mode.

In the case of the BIOS or OS controlling the power management of the display controller, in one embodiment the reduced power mode of the display controller is selected from a group of device modes provided by Advanced Power Management (APM) BIOS Interface Specification, February 1996. The APM device modes that may be implemented when reducing the power of the display controller include Power Managed Device Mode (device fully powered), Device Power Managed (device is working but some features may not be operational), Device Low Power (device is not working, but power is maintained), and Device Off (device is not working and device is powered off). In alternative embodiments, less than all modes described above may be implemented, and/or additional modes not described may be implemented. Furthermore, in one embodiment, reducing the power consumption of the display may also be performed in accordance the APM BIOS Interface Specification as described above.

In response to a need/request to increase power to the display, in process 214, the voltage and operating frequency of the display controller are increased to support an increase in power and operations by the display. In one embodiment, the voltage and frequency of the display controller are increased per the same procedures and/or processes in which the voltage and frequency were decreased.

After the display controller has resumed operations, in process 216 the display also resumes operations. In one embodiment, the display controller restores the horizontal scan frequency and/or the vertical scan frequency signals to the display.

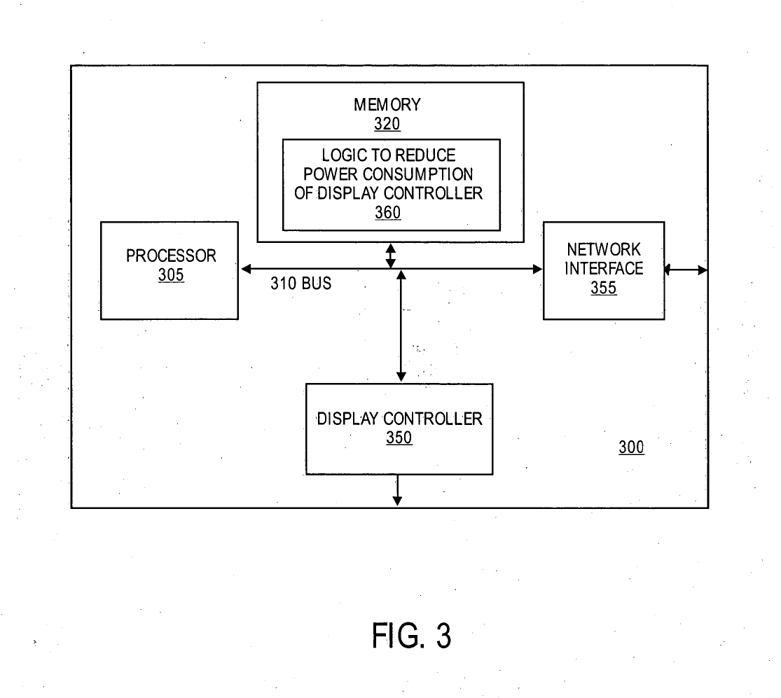

The block diagram of FIG. 3 illustrates a system 300 to reduce power consumption of a display controller in accordance with one embodiment. The system includes a processor 305 which is coupled to a bus 310. A memory 320 coupled to bus 310. In one embodiment, the memory is a dynamic random access memory (DRAM) module. In one embodiment, the system includes a network interface 355 to have the system communicate with networks external to the system. The system further includes a display controller 350 to support a display, and logic 360 to reduce power consumption of a display controller in accordance with one embodiment. In one embodiment, in the case of activation of the Always On Mode, many of the components within the system 300 (e.g. the display, display controller, processor) could be placed in a reduced power consumption mode, and the network interface 355 would continue to operate to receive communications from an external network.

In one embodiment, the logic to reduce power consumption of the display controller can be stored in the memory of the system as a set of instructions to be executed. In addition, the instructions to perform the techniques described above could alternatively be stored on other forms of machine readable media, including magnetic and optical disks. For example, the method of the techniques described could be stored on machine readable media, such as magnetic disks or optical disks, which are accessible via a disk drive. Further, the instructions can be downloaded into a computing device over a data network in a form of compiled and linked version.

Alternatively, the logic to reduce power consumption of the display controller as discussed above, could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
identify an occurrence of a predetermined event; and
reducing power consumption of a display controller in response to the predetermined event.

2. The method of claim 1, wherein identifying the occurrence of the event comprises identifying a display is in a reduced power mode.

3. The method of claim 1, wherein reducing power consumption of the display controller includes copying states of the display controller into a memory.

4. The method of claim 2, wherein identifying the display in a reduced power mode includes the power mode of the display being reduced in response to a system activation of an Always On mode.

5. The method of claim 3, wherein the Always On mode includes reducing the power mode of multiple components in the system and at least one component of the system remaining powered on to receive network communications from an external network.

6. The method of claim 1, wherein the display controller is integrated on a chipset and reducing power consumption of the display controller includes maintaining power to a remainder of the chipset.

7. The method of claim 1, wherein a display controller reduced power mode is selected from a group consisting of Device Power Managed, Device Low Power, and Device Off.

8. The method of claim 1, further comprising reducing power of a rasterizer and maintaining power of the display controller in response to identifying the display in a reduced power mode, identifying absence of a user, and identifying user input activity.

9. A machine-readable medium embodying instructions, the instructions, when executed by a processor, causing the processor to perform operations comprising:
identifying an occurrence of a predetermined event; and
reducing power consumption of a display controller in response to the detection of a predetermined event.

10. The machine-readable medium of claim 9, wherein the machine-readable medium further includes instructions, when accessed, results in the processor performing the operations comprising:
identifying the occurrence of an event comprises identifying a display in a reduced power mode.

11. The machine-readable medium of claim 10, wherein the machine-readable medium further includes instructions, when accessed, results in the processor performing operations comprising:
identifying the display in a reduced power mode including the power mode of the display being reduced in response to a system activation of an Always On mode.

12. The machine-readable medium of claim 9, wherein the Always On mode comprises reducing the power mode of multiple components in the system and at least one component of the system remaining powered on to receive network communications from an external network.

13. The machine-readable medium of claim 9, wherein the display controller is integrated on a chipset.

14. The machine-readable medium of claim 13, wherein the machine-readable medium further includes instructions, when accessed, results in the processor performing operations comprising:
reducing the power consumption of the display controller and maintaining power to a remainder of the chipset.

15. The machine-readable medium of claim 9, wherein a display controller reduced power mode is selected from a group consisting of Device Power Managed, Device Low Power, and Device Off.

16. The machine-readable medium of claim 9, wherein the machine-readable medium further includes instructions, when accessed, results in the processor performing operations comprising: reducing power of a rasterizer and maintaining power of the display controller in response to identifying the display in a reduced power mode, identifying absence of a user, and identifying user input activity.

17. A computer system comprising:
a processor;
a network interface coupled to the processor; and
a machine-readable medium embodying instructions, the instructions, when executed by a processor, causing the processor to perform operations comprising:
identifying an occurrence of a predetermined event; and
reducing power consumption of a display controller in response to the detection of a predetermined event.

18. The computer system of claim 17, wherein identifying the occurrence of an event comprises identifying a display in a reduced power mode.

19. The computer system of claim 17, wherein identifying the display in a reduced power mode includes the power mode of the display being reduced in response to a system activation of an Always On mode.

20. The computer system of claim 19, wherein the Always On mode includes reducing the power mode of multiple components in the system and at least one component of the system remaining powered on to receive network communications from an external network.

21. The computer system of claim 17, wherein the display controller is integrated on a chipset and reducing power consumption of the display controller includes maintaining power to a remainder of the chipset.

22. The computer system of claim 17, wherein the machine-readable medium further includes instructions which when expected, cause the processor to reduce power consumption of a rasterizer and maintain power of the display controller in response to identifying the display in a reduced power mode and identifying user input activity.
